(19) United States
(12) Patent Application Publication
(10) Pub. No.: US 2004/0220941 A1
(43) Pub. Date: Nov. 4, 2004

(54) Sorting variable length keys in a database

(76) Inventors: Mark R. Nielson, Elkhorn, NE (US); John I. Ayers, Omaha, NE (US); Georg T. Trimborn, Skokie, IL (US); John H. Pineda, Omaha, NE (US); Mark A. Montz, Elkhorn, NE (US); Nabil F. Salama, Omaha, NE (US); Rob W. Heldenbrand, Omaha, NE (US); Sharon Lim, Plano, TX (US); Michael R. Kelly, Omaha, NE (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/426,189

(22) Filed: Apr. 30, 2003

(51) Int. Cl. G06F 7/00

(52) U.S. Cl. 707/100

(57) ABSTRACT

Methods, devices, architectures and data structures are provided for sorting variable length keys in a database. An embodiment includes a variable length key having a series of octets. Each octet includes a pair of hexadecimal values, e.g. representing digits. At least one octet includes a sort key having a value representing a digit length for a received variable length key minus a minimum digit length of an object key.

A Public Switched Telephony Network (PSTN) refers to the public phone networks as known by those of ordinary skill in the art. The PSTN is composed of switches and T1/E1 trunks, central office, etc. The PSTN uses circuit-switched technology, in which necessary resources are allocated (dedicated) for the duration of a phone call. An IP network (e.g., the Internet), in contrast, is composed of nodes of computers, serves, routers, and communications links, etc. The IP network employs packet-switching technology that decomposes data (e.g., voice, web pages, e-mail messages, etc.) into IP packets. Each packet is then transmitted over an IP network to a destination identified by an IP address and reassembled at the destination. An IP transmission is completed without pre-allocating resources from point to point.

As one of ordinary skill in the art will appreciate upon reading this disclosure, a wireless infrastructure can provide cellular/PCS services like call origination and call delivery for a roaming mobile device or handset. For call delivery, a visited network tracks the location of a roaming user and a Visitors Location Register (VLR) reports that location information via a control network to the Home Location Register (HLR) of the home network. Control networks may include ANSI-41 and GSM MAP types of networks. An Authentication Center (AC) in a home network can be used for user registration and authentication, e.g., checking to see, among other things, if the user has made payments. When a call relayed from the Public Switched Telephony Network (PSTN) to the home MSC is to be delivered to a subscriber, the home Mobile Switching Center (MSC) consults the HLR to determine the current whereabouts of the current VLR, and the call is then directed via links and the PSTN to the visited Mobile Switching Center (MSC) currently serving the mobile device.

Accordingly, whenever a telecommunications subscriber dials a telephone number for the mobile device, the HLR is queried by the mobile network to determine the current location of the mobile device. Utilizing the stored network address in the HLR representing the serving MSC, the HLR requests a roaming number from the serving MSC in response to the receipt of the query signal. The roaming number provided by the serving MSC is then used by the telecommunications network to route the incoming signal towards the serving MSC. The serving MSC then pages the mobile device and accordingly establishes a speech connection with the mobile device, if available.

If the mobile device roams out of the serving MSC coverage area and into another MSC coverage area, the MSC will hand-off the communication to another MSC and base station cell, if available. To ensure compatibility between two MSCs, the procedures and protocol for the format and transmission of messages have been standardized. For an identification of industry standards relating to these communications, reference is made to ANSI/TIA/EIA Standard 41, “Cellular Radio telecommunications Intersystem Operations.” The format for messages between two MSCs, as specified by ANSI/TIA/EIA-41, is an 8-octet structure.

In an International Mobile Subscriber Identity (IMSI) environment messages may be specified as a 10-octet structure, or greater. Each octet represents a byte, or 8 bits of data represented in Hexadecimal form. In the IMSI architecture/network, the IMSI key type will support number digit lengths from 6 to 18. Such numbers are stored upon databases within a network for use in providing mobile service. A database may include multiple disk drives to store the volume of IMSI numbers.

Currently, only a method of storing fixed length objects (keys) exists among wireless infrastructures. According to this method the keys are stored according to a key length order.

### BRIEF DESCRIPTION OF THE DRAWINGS

FIG. 1 is a block diagram of an embodiment of a wireless subscriber network.

FIG. 2 illustrates an embodiment of a database interfaced with a network.

FIG. 3A illustrates a table of variable length keys presented in a conventional sorting order.

FIG. 3B illustrates a table embodiment of variable length keys sorted in ascending/display order.

FIG. 4 illustrates an embodiment of data structures, represented as a series of octets for variable length keys, presented in ascending order.

FIG. 5 illustrates an embodiment for interfacing or migrating variable length keys from a number of different standard databases to an interoperable (universal) database.

### DETAILED DESCRIPTION

Embodiments of the present invention provide for variable length keys (objects) to be sorted and/or stored according to an ascending display order. In this manner, a program user is able to sequentially access the keys (objects) from a database in a more intuitive, e.g. “read next”, order as the user would logically expect to view the same.

As one of ordinary skill in the art will appreciate, an IMSI and similar mobile identifiers, e.g. mobile identification numbers (MINs), can be used as a primary key for a database. As noted above, the IMSI key length is a variable key length. The IMSI key type will support digit lengths from 6 to 18.

Embodiments of the present invention are operable on a received variable length key to create a sort byte having a value representing a digit length in the received variable length key minus a minimum digit length of an object key. Embodiments are operable to position the sort byte as a next subsequent octet following a number of octets used for the minimum digit length of the object key to create a new index key. In various embodiments, the new index key can be used as an alternative index for keying a database.

In one embodiment, the variable length key is an IMSI key type and a minimum digit length of the object key is six digits. In this embodiment, the sort byte is positioned in a fourth octet. The invention, however, is not so limited.

As one of ordinary skill the art will understand, the embodiments can be performed by software, application modules, and computer executable instructions operable on the systems and devices shown herein or otherwise. The invention, however, is not limited to any particular operating environment or to software written in a particular programming language. Software, application modules and/or computer executable instructions, suitable for carrying out embodiments of the present invention, can be resident in one or more devices or locations or in several and even many locations.

Unless explicitly stated, the method embodiments described herein are not constrained to a particular order or sequence. Additionally, some of the described method embodiments can occur or be performed at the same point in time.

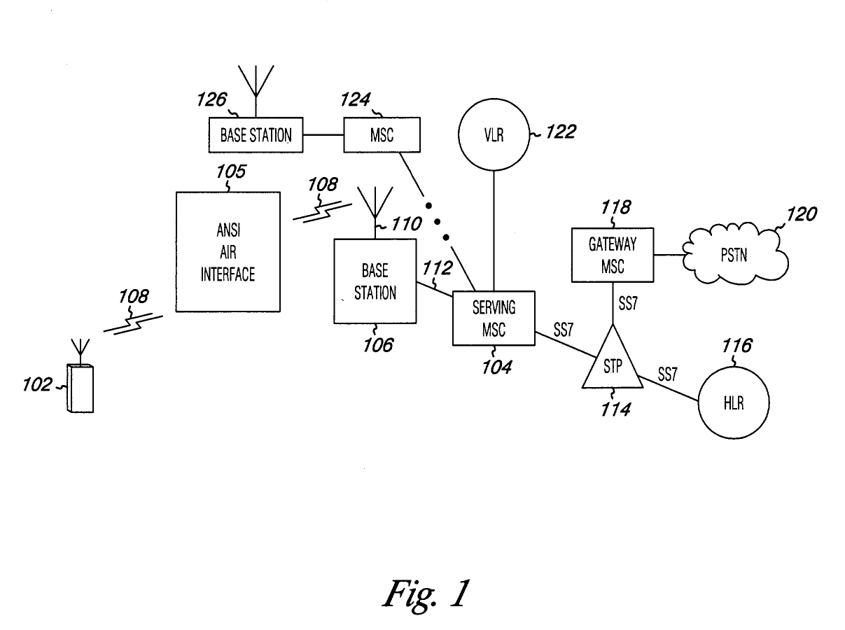

FIG. 1 is a block diagram of an embodiment of a wireless subscriber network. In FIG. 1 a mobile device or handset 102 is illustrated communicating with a mobile switching center (MSC) 104 such as in a code division multiple access (CDMA) cellular communications system. System configuration and operation of a CDMA cellular communications system is well known to those skilled in the art. Accordingly, detailed information concerning CDMA system configuration and operation is not provided. However, technical information concerning this topic may be obtained by referring to a number of available documents. For example, for a description of the use of CDMA techniques in a multiple access communications system, reference is made to U.S. Pat. No. 4,901,307, entitled “Spread Spectrum Multiple Access Communication System Using Satellite or Terrestrial Repeaters.” Furthermore, for a description of the generation of signal waveforms for use in a CDMA communications system, reference is made to U.S. Pat. No. 5,103,459, entitled “System and Method for Generating Signal Waveforms in a CDMA Cellular System” and U.S. Pat. No. 5,883,888, entitled “Seamless Soft Handoff in a CDMA Cellular Communications System.” The disclosures of the foregoing references are expressly incorporated by reference herein.

The heart of a typical wireless telecommunications system is the Mobile Switching Center (MSC) that is connected to a plurality of base stations that are dispersed throughout the geographic area serviced by the system. The geographic area serviced by a wireless telecommunications system is partitioned into a number of spatially distinct areas called “cells.” Each MSC is responsible for, among other things, establishing and maintaining calls between mobile devices and between a mobile device and a wireline terminal, which is connected to the system via the local and/or long-distance networks. A MSC is a telephone switch specialized for wireless and mobility support. A MSC performs various functions, including mobility management, call handoffs, call admission, call control, resource allocation, and so forth. The call is then relayed from the MSC to base stations and via wireless communications to the mobile device.

In FIG. 1, whenever the mobile device 102 activates or roams into a new MSC coverage area, i.e., the “cell” for which the MSC is responsible, the new MSC becomes the serving MSC. The mobile device transmits its stored subscriber profile to the new serving MSC via a base station (BS) 106. As shown in FIG. 1, the subscriber profile information is transmitted over a radio channel 108 in a format complicate with an air interface standard and detected by an antenna 110 of BS 106.

Base station 106, in turn, transmits at least a portion of the subscriber profile information to the serving MSC 104, such as for example via communication line 112. The procedures and protocol for communication between the base station 106 and the MSC 104 have also been standardized. For an identification of industry standards relating to these communications, reference is made to TIA/EIA/IS634-A, “MSC-BS Interface for Public Wireless Communication Systems.” The format for messages between base station 106 and MSC 106 is a variable octet field.

In order to provide mobile service to the newly registered mobile device 102, the serving MSC 104 transmits a Mobile Application Part (MAP) based signal, such as a registration notification signal (IS-41 message) or location update signal (GSM message), to a home location register (HLR) 116 via a signaling link such as a signal transfer point (STP) 114. An STP is a node in the signaling system 7 (SS7) telephone network that routes messages between exchanges and between exchanges and databases that hold subscriber and routing information. An HLR is one such database in a cellular system that contains all the subscribers within the provider's home service area. The data in the HLR is requested and transferred via SS7 to the visitor location register (VLR) in the new area.

In the embodiment of FIG. 1, the STP 114 routes the MAP based signal to a gateway MSC 118. As shown in FIG. 1, the gateway MSC 118 can serve as a network switch for connecting to the public switched telephone network (PSTN) 120. SS7 is the protocol used in the PSTN for setting up calls and providing services. The SS7 network sets up and tears down the call, handles all the routing decisions and supports all modern telephony services, such as local number portability (LNP). LNP allows a telephone subscriber to port his/her phone number when that subscriber relocates to a different region of the country, even when the local area code may be different. The voice switches know as service switching points (SSPs) query service control point (SCP) databases using packet switches known as signal transfer points (STPs).

Accessing databases using a separate signaling network enables the system to more efficiently obtain static information such as the services a customer has signed up for and dynamic information such as ever-changing traffic conditions in the network. In addition, a voice circuit is not tied up until a connection is actually made between both parties. There is an international version of SS7 standardized by the ITU, and national versions determined by each country. For example, ANSI governs the US standard for SS7, and Telcordia (Bellcore) provides an extension of ANSI for its member companies.

The MAP based signal informs the HLR 116 of the network address associated with the MSC 104 currently serving the mobile device 102 and also request requisite subscriber information for providing mobile service to the roaming mobile device 102. The HLR 116 updates its database to store the network address representing the serving MSC 104 and also copies the requesting subscriber information to a visitor location register (VLR) 122 associated with the serving MSC 104. The network address representing the serving MSC 104 stored in the HLR 116 is later utilized by the mobile network to reroute any incoming call intended for the mobile device 102 to the serving MSC 104.

Accordingly, whenever a telecommunications subscriber dials a telephone number for the mobile device 102, the HLR 116 is queried by the mobile network to determine the current location of the mobile device 102. Utilizing the stored network address in HLR 116 representing the serving MSC 104, the HLR 116 requests a roaming number from the serving MSC 104 in response to the receipt of the query signal. The roaming number provided by the serving MSC 104 is then used by the telecommunications network to route the incoming signal towards the serving MSC 104. The serving MSC 104 then pages the mobile device 102 and accordingly establishes a speech connection with the mobile device 102, if available. If the mobile device 102 roams out of serving MSC 104 coverage area and into another MSC 124 coverage area, MSC 104 will hand-off the communication to MSC 124 and base station 126.

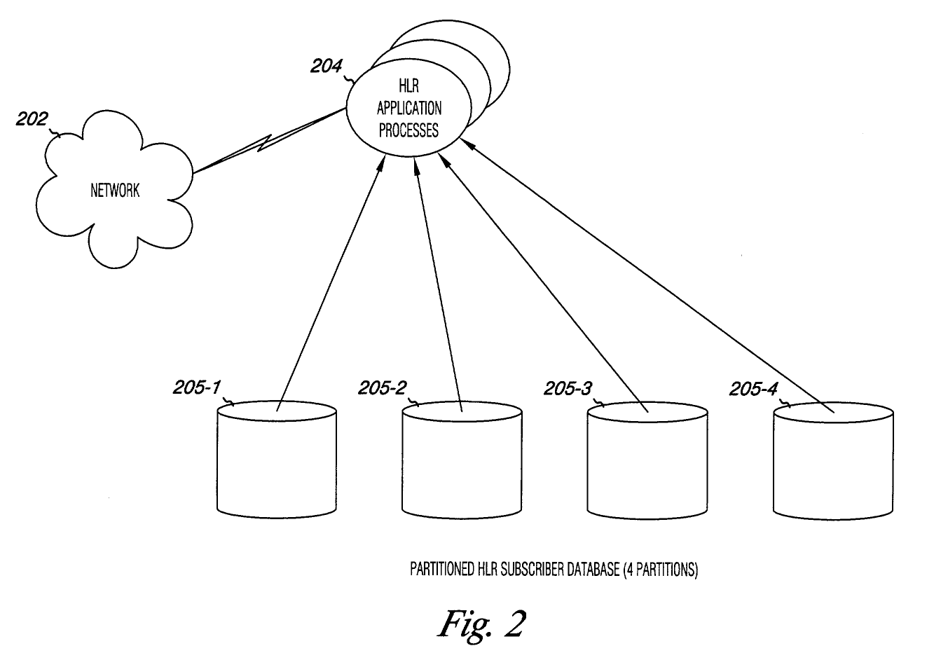

FIG. 2 illustrates an embodiment of a database interfaced with a network. The embodiment of FIG. 2 illustrates a mobile control network 202, such as an ANSI-41 and/or GSM MAP type of network, including an interface to a database 204. Database 204 includes one or more sets of computer executable instructions, software, and/or application modules for managing and partitioning data within database 204. In the embodiment of FIG. 2 the database is an HLR 204. The invention, however, is not limited to an HLR database. In the embodiment of FIG. 2, the HLR 204 subscriber database has been partitioned into four key ranges, e.g. 205-1, 205-2, 205-3, and 205-4. The invention however, is not limited to partitioning a database into four key ranges. Fewer or more key range partitions are considered within the scope of the present invention.

As noted above, fixed length objects (keys) can be stored among various partitions or key ranges in a database. Traditionally, the keys are stored according to a “key length” order. For databases keyed with variable length keys this poses problems since the arrangement, sorting, ordering, and/or storing of the variable length keys among the partitions, or within a single partition, will oftentimes not be in an intuitive or logical order. That is, the ordering does not lend itself to a “read next” processing to provide a next expected number series.

According to embodiments of the present invention, variable length keys (objects) can be sorted and/or stored according to an ascending display order. In this manner, a program user is able to sequentially access the keys (objects) from a database in a more intuitive, e.g. “read next”, order as the user would logically expect to view the same.

As shown in the embodiment of FIG. 2, one or more sets of executable instructions are operable on database 204 to perform embodiments of the invention. These embodiments include receiving variable length keys arranged in octets. As one of ordinary skill in the art will appreciate an octet is a telecommunications term for a byte. Receiving variable length keys arranged in octets includes receiving variable length keys wherein each octet includes a pair of hexadecimal values representing digits.

The left four most bits represented by a hexadecimal value can be referred to as the high order nibble and the right four most bits in a hexadecimal value can be referred to as the low order nibble. And as used herein, the left four most bits are also referred to as a first one of a hexadecimal pair that represents 8 binary bits. The right four most bits are also referred to as a second one of the hexadecimal pair.

The set of executable instructions are operable to create, subsequently read, interpret and/or understand a sort byte having a value representing a digit length in a received variable length key minus a minimum digit length for an object key. In various embodiments, creating the sort byte includes providing a pad hexadecimal value in a first one of the pair (e.g. the high order nibble) and providing a value representing how many digits the received variable length key exceeds the minimum digit length for the object key in a second one of the pair (e.g. the low order nibble). In various embodiments, an entire byte may be used to represent how many digits the received variable length key exceeds the minimum digit length for the object key. Additionally, several sort bytes can be created and implemented according to the various embodiments depending on the value needed to represent how many digits the received variable length key exceeds the minimum digit length for the object key. Thus, although reference is made herein to a sort byte, the invention is not limited to a byte and all or less than a byte may be used in the various embodiments.

The executable instructions are further operable to position the sort byte as a next subsequent octet(s) following a number of octets used for the minimum digit length for the object key to create a new index key. In various embodiments, receiving variable length keys includes receiving international mobile subscriber identity (IMSI) key types and positioning includes positioning the sort byte in a fourth octet following a six digit object key.

The executable instructions are further operable to arrange the received variable length keys in an ascending order. In various embodiments, arranging the received variable length keys in an ascending order includes using a first octet, a second octet, and using the sort byte to order keys having identical first and second octets. In this manner, the executable instructions are operable to arrange received keys in an ascending/display order.

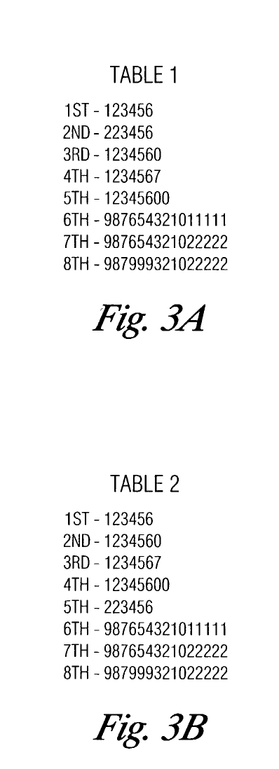

FIG. 3A illustrates a table, e.g. TABLE 1, showing variable length keys presented in a conventional sorting order. That is, sorting and/or storing only by using the key length order results in the 2ND entry being logically, or intuitively, misplaced. A user would not access an expected “read next” number by scrolling through the index.

FIG. 3B illustrates a table, e.g. TABLE 2, embodiment of variable length keys sorted in ascending/display order. As shown in FIG. 3B, using a sort byte, according to the various embodiments described herein, results in a more logical/intuitive ascending display order. For example, when a first and a second octet in a variable length key are identical, the sort byte can be used to further sort and/or store the key in the order shown. In FIG. 3B, the entries are presented in an “expected read next” manner. As illustrated, the 5TH entry, which was previously ordered as the 2ND entry in FIG. 3A, now can be accessed, processed, and displayed in a logical sequence.

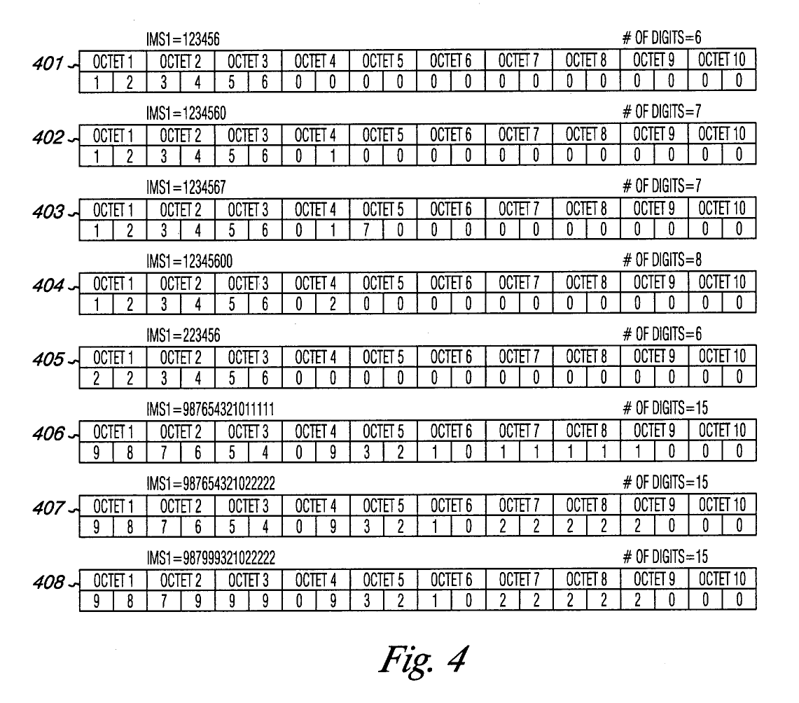

FIG. 4 illustrates an embodiment of data structures, represented as a series of octets for variable length keys, presented in ascending order. That is, FIG. 4 illustrates a number of variable length keys, such as a series of international mobile subscriber identity (IMSI) numbers, represented by 10 octets.

In the embodiment of FIG. 4, a first variable length IMSI key 401 representing the number 123456 is shown. For IMSI key types, the minimum digit length of an object key is six. As such, as illustrated in this embodiment, a fourth octet is used as a sort byte as the same has been described herein.

The first IMSI key 401 uses the first three octets and the digits for the number are reflected in the pairs of hexadecimal values within each octet accordingly (e.g. 1, 2; 3, 4; and 5, 6). Since the received variable length key is equal to the minimum digit length of the object key, the sort byte reflects a value of 0 in the second one of the pair of hexadecimal values. The first one of the pair is unused in this embodiment and includes a filler value of 0. In various embodiments the first one or the pair can include a pad hexadecimal value. The invention is not so limited. Octets 5 and 10 include unused digits, represented by 0's.

In FIG. 4, a second variable length IMSI key 402 representing the number 1234560 is shown. The second IMSI key 402 uses the first three octets for the first six digits (1, 2; 3, 4; and 5, 6), and the sort byte is presented as the fourth octet. Since the received variable length key is greater than the minimum digit length of the object key, the sort byte value is equal to the digit length of the received variable length key (e.g. 7) minus the minimum digit length for the object key (e.g. 6). Accordingly, the sort byte reflects a 1 shown in the second one of the pair of hexadecimal values. The fifth octet then reflects the value (0) of the 7th digit in the received variable length key (1234560) as presented in the first one of the pair of hexadecimal values in the fifth octet. The second one of the pair is unused and includes a filler value of 0. Octets 6 and 10 include unused digits, represented by 0's.

A third variable length IMSI key 403 representing the number 1234567 is shown next. The third IMSI key 403 uses the first three octets for the first six digits (1, 2; 3, 4; and 5, 6), and the sort byte is presented as the fourth octet. Using the values in the octets having significant digits as contained in the originally received variable length key, in conjunction with the sort byte, has logically placed this variable length key entry in its logical, intuitive, “read next” processing location. Since the received variable length key is greater than the minimum digit length of the object key, the sort byte value is equal to the digit length of the received variable length key (e.g. 7) minus the minimum digit length for the object key (e.g. 6). Accordingly, the sort byte reflects a 1 shown in the second one of the pair of hexadecimal values. The fifth octet then reflects the value (7) of the 7th digit in the received variable length key (1234567) as presented in the first one of the pair of hexadecimal values in the fifth octet. The second one of the pair is unused and includes a filler value of 0. Octets 6 and 10 include unused digits, represented by 0's.

A fourth variable length IMSI key 404 representing the number 12345600 is shown next. The fourth IMSI key 404 uses the first three octets for the first six digits (1, 2; 3, 4; and 5, 6), and the sort byte is presented as the fourth octet. Using the values in the octets having significant digits as contained in the originally received variable length key, in conjunction with the sort byte, has logically placed this variable length key entry in its logical, intuitive, “read next” processing location. Since the received variable length key is greater than the minimum digit length of the object key, the sort byte value is equal to the digit length of the received variable length key (e.g. 8) minus the minimum digit length for the object key (e.g. 6). Accordingly, the sort byte reflects a 2 shown in the second one of the pair of hexadecimal values. The fifth octet then reflects the values (0 and 0) of the 7th and 8th digits in the received variable length key (12345600) as presented in the first one and the second one of the pair of hexadecimal values in the fifth octet. Octets 6 and 10 include unused digits, represented by 0's.

A fifth variable length IMSI key 405 representing the number 223456 is shown next. The fifth IMSI key 405 uses the first three octets for the first six digits (2, 2; 3, 4; and 5, 6), and the sort byte is presented as the fourth octet. Using the values in the octets having significant digits as contained in the originally received variable length key, in conjunction with the sort byte, has logically placed this variable length key entry in its logical, intuitive, “read next” processing location. Since the received variable length key is equal to the minimum digit length of the object key, the sort byte reflects a value of 0 in the second one of the pair of hexadecimal values. Octets 5 and 10 include unused digits, represented by 0's.

A sixth variable length IMSI key 406 representing the number 987654321011111 is shown next. The sixth IMSI key 406 uses the first three octets for the first six digits (9, 8; 7, 6; and 5, 4), and the sort byte is presented as the fourth octet. Using the values in the octets having significant digits as contained in the originally received variable length key, in conjunction with the sort byte, has logically placed this variable length key entry in its logical, intuitive, “read next” processing location. Since the received variable length key is greater than the minimum digit length of the object key, the sort byte value is equal to the digit length of the received variable length key (e.g. 15) minus the minimum digit length for the object key (e.g. 6). Accordingly, the sort byte reflects a 9 shown in the second one of the pair of hexadecimal values. The fifth octet through the eighth octet reflects the next eight digits in sequence (e.g. 3, 2; 1, 0; 1, 1; and 1, 1). And the ninth octet then reflects the value (1) of the 15th digit in the received variable length key (987654321011111) as presented in the first one of the pair of hexadecimal values. The second one of the pair of hexadecimal values in the ninth octet reflects an unused digit represented by a 0. Octet 10 includes unused digits, represented by 0's.

A seventh variable length IMSI key 407 representing the number 987654321022222 is shown next. The seventh IMSI key 407 uses the first three octets for the first six digits (9, 8; 7, 6; and 5, 4), and the sort byte is presented as the fourth octet. Using the values in the octets having significant digits as contained in the originally received variable length key, in conjunction with the sort byte, has logically placed this variable length key entry in its logical, intuitive, “read next” processing location. Since the received variable length key is greater than the minimum digit length of the object key, the sort byte value is equal to the digit length of the received variable length key (e.g. 15) minus the minimum digit length for the object key (e.g. 6). Accordingly, the sort byte reflects a 9 shown in the second one of the pair of hexadecimal values. The fifth octet through the eighth octet reflect the next eight digits in sequence (e.g. 3, 2; 1,0; 2, 2; and 2, 2). And the ninth octet then reflects the value (2) of the 15th digit in the received variable length key (987654321022222) as presented in the first one of the pair of hexadecimal values. The second one of the pair of hexadecimal values in the ninth octet reflects an unused digit represented by a 0. Octet 10 includes unused digits, represented by 0's.

An eight variable length IMSI key 408 representing the number 987999321022222 is shown next. The eighth IMSI key 408 uses the first three octets for the first six digits (9, 8; 7, 9; and 9, 9), and the sort byte is presented as the fourth octet. Using the values in the octets having significant digits as contained in the originally received variable length key, in conjunction with the sort byte, has logically placed this variable length key entry in its logical, intuitive, “read next” processing location. Since the received variable length key is greater than the minimum digit length of the object key, the sort byte value is equal to the digit length of the received variable length key (e.g. 15) minus the minimum digit length for the object key (e.g. 6). Accordingly, the sort byte reflects a 9 shown in the second one of the pair of hexadecimal values. The fifth octet through the eighth octet reflect the next eight digits in sequence (e.g. 3, 2; 1,0; 2, 2; and 2, 2). And the ninth octet then reflects the value (2) of the 15th digit in the received variable length key (987999321022222) as presented in the first one of the pair of hexadecimal values. The second one of the pair of hexadecimal values in the ninth octet reflects an unused digit represented by a 0. Octet 10 includes unused digits, represented by 0's.

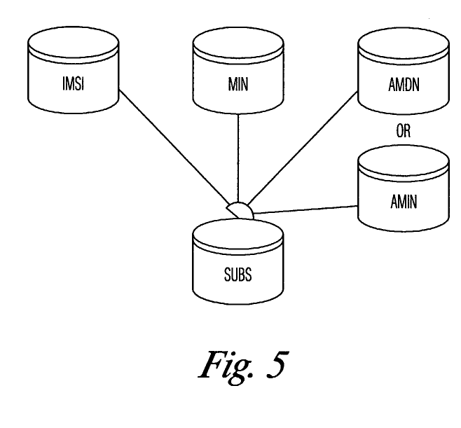

FIG. 5 illustrates an embodiment for interfacing or migrating variable length keys from a number of different standard databases to an interoperable (universal) database. As shown in the embodiment of FIG. 5, embodiments of the invention can be used to migrate key types from a number of differently keyed databases into a SUBS database 502 by implementing a sort byte described herein. Thus, an IMSI database 504, keyed by variable length IMSI key types, can be translated to be accessed in the SUBS database 502. A mobile identification number (MIN) database, keyed by MIN numbers, can be translated to be accessed in the SUBS database 502. An alias mobile identification number (AMIN) or alias mobile directory number (AMDN) database, 506 and 508 respectively can similarly be translated to be accessed in the SUBS database 502.

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the invention. It is to be understood that the above description has been made in an illustrative fashion, and not a restrictive one. Combination of the above embodiments, and other embodiments not specifically described herein will be apparent to those of skill in the art upon reviewing the above description. The scope of the various embodiments of the invention includes any other applications in which the above structures and methods are used. Therefore, the scope of various embodiments of the invention should be determined with reference to the appended claims, along with the full range of equivalents to which such claims are entitled.

It is emphasized that the Abstract is provided to comply with 37 C.F.R. § 1.72(b) requiring an Abstract that will allow the reader to quickly ascertain the nature of the technical disclosure. It is submitted with the understanding that it will not be used to limit the scope of the claims.

In the foregoing Detailed Description, various features are grouped together in a single embodiment for the purpose of streamlining the disclosure. This method of disclosure is not to be interpreted as reflecting an intention that the embodiments of the invention require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A mobile subscriber database, comprising:
a computer readable medium having a set of executable instructions to sort variable length keys in the database; and
wherein the set of executable instructions is operable on a received variable length key to create a sort byte having a value representing a digit length in the received variable length key minus a minimum digit length for an object key.

2. The database of claim 1, wherein the executable instructions are operable to position the sort byte as a next subsequent octet, following a number of octets used for the minimum digit length for the object key, to create a new index key.

3. The database of claim 2, wherein the executable instructions are operable to sort new index keys in reference to a first and a second octet, and wherein the sort byte is used to order keys having identical first and second octets to arrange received keys in an ascending/display order.

4. The database of claim 3, wherein each octet includes a pair of hexadecimal values representing digits, and wherein for the sort byte a first one of the pair includes a filler hexadecimal value and a second one of the pair represents how many digits the received variable length key exceeds the minimum digit length for the object key.

5. The database of claim 1, wherein the variable length keys include international mobile subscriber identity (IMSI) (key types) numbers.

6. The database of claim 1, wherein the database further includes one or more memory partitions each having a defined key range.

7. A database including mobile subscribers, comprising:
one or more storage locations;
a computer readable medium connected thereto and having a set of executable instructions to sort variable length key types;
the executable instructions operable on a received variable length key to create a sort byte having a value representing a digit length in the received variable length key minus a minimum digit length for an object key; and
the executable instructions operable to position the sort byte as a next subsequent octet following a number of octets used for the minimum digit length for the object key to create a new index key.

8. The database of claim 7, wherein the executable instructions are operable to sort new index keys in reference to a first and a second octet, and wherein the sort byte is used to order keys having identical first and second octets to arrange received keys in an ascending/display order.

9. The database of claim 7, wherein the executable instructions are operable to store, read, interpret, and understand the new index keys as an alternative index to the database.

10. The database of claim 7, wherein the database is a network administration database.

11. The database of claim 7, wherein the database is a visitor location register (VLR).

12. A dynamic provisioning architecture, comprising:
a database including mobile subscriber information; and
logic means operably coupled to the database to;
create a sort byte having a value representing a digit length in a received variable length key minus a minimum digit length for an object key; and
position the sort byte as a next subsequent octet following a number of octets used for the minimum digit length for the object key.

13. The architecture of claim 12, wherein the variable length keys include a series of octets, wherein each octet includes a pair of hexadecimal values representing digits, and wherein the logic means is operable to create a new index key including the sort byte.

14. The architecture of claim 13, wherein the logic means is operable store new index keys in the database in an ascending/display order.

15. The architecture of claim 12, wherein the variable length keys are international mobile subscriber identity (IMSI) key types, the minimum digit length for an object key is six (6), and the next subsequent octet is a fourth octet.

16. The architecture of claim 12, wherein the logic means includes a set of computer executable instructions.

17. A computer readable medium having instructions stored thereon to cause a device to perform a method, comprising:
receiving variable length keys arranged in octets; and
arranging the received variable length keys in an ascending order.

18. The computer readable medium of claim 17, wherein arranging the received variable length keys in an ascending order includes defining alias mobile identification numbers.

19. The computer readable medium of claim 17, wherein arranging the received variable length keys in an ascending order includes defining alias mobile directory numbers.

20. The computer readable medium of claim 17, where the method further includes creating a sort key having a value representing a digit length in a received variable length key minus a minimum digit length for an object key.

21. The computer readable medium of claim 20, wherein the method further includes positioning the sort key as a next subsequent octet(s) following a number of octets used for the minimum digit length for the object key to create a new index key.

22. The computer readable medium of claim 17, wherein the method further includes using received variable length keys arranged in an ascending order as an alternative index to a database.

23. The computer readable medium of claim 17, wherein the method further includes using received variable length keys arranged in an ascending order as a primary index to a database.

24. The computer readable medium of claim 17, wherein the method further includes displaying received variable length keys arranged in an ascending order.

25. A method for sorting variable length keys in a database, comprising:
receiving variable length keys arranged in octets; and
creating a sort byte having a value representing a digit length in a received variable length key minus a minimum digit length for an object key.

26. The method of claim 25, wherein the method further includes positioning the sort byte as a next subsequent octet following a number of octets used for the minimum digit length for the object key to create a new index key.

27. The method of claim 26, wherein receiving variable length keys includes receiving international mobile subscriber identity (IMSI) key types, wherein positioning includes positioning the sort byte in a fourth octet following a six digit object key.

28. The method of claim 25, wherein each octet includes a pair of hexadecimal values representing digits, and wherein creating the sort byte includes providing a pad hexadecimal value in a first one of the pair and providing a value representing how many digits the received variable length key exceeds the minimum digit length for the object key in a second one of the pair.

29. The method of claim 25, wherein the method further includes arranging the received variable length keys in an ascending order.

30. The method of claim 29, wherein arranging the received variable length keys in an ascending order includes using a first and a second octet, and wherein the sort byte is used to order keys having identical first and second octets to arrange received keys in an ascending/display order.

31. A data structure in a database, comprising:
a variable length key having a series of octets;
wherein each octet includes a pair of hexadecimal values representing digits; and
wherein at least one octet includes a sort byte having a value representing a digit length for a received variable length key minus a minimum digit length of an object key.

32. The data structure of claim 31, wherein the variable length key includes an international mobile subscriber identity (IMSI) key type.

33. The data structure of claim 31, wherein the minimum digit length of the object key is six digits such that the first three octets of the variable length octet represent the object key.

34. The data structure of claim 31, wherein sort byte is provided as a next subsequent octet following a number of octets used for the minimum digit length of the object key.

35. The data structure of claim 31, wherein the sort byte is provided in the fourth octet.
